(19) United States
(12) Patent Application Publication
(10) Pub. No.: US 2017/0019595 A1
(43) Pub. Date: Jan. 19, 2017

(54) IMAGE PROCESSING METHOD, IMAGE PROCESSING DEVICE AND DISPLAY SYSTEM

(71) Applicant: PROLIFIC TECHNOLOGY INC., Taipei (TW)

(72) Inventors: Guan-Yu CHEN, Hsinchu City (TW); Hsin-Yueh CHANG, Zhubei City (TW); Heng-Chi HSU, Taipei City (TW)

(73) Assignee: PROLIFIC TECHNOLOGY INC., Taipei (TW)

(21) Appl. No.: 15/209,742

(22) Filed: Jul. 13, 2016

(30) Foreign Application Priority Data
Jul. 14, 2015 (TW) 104122716

(51) Int. Cl. H04N 5/232; G02B 13/00; G06T 3/00; G06T 11/60; G06T 5/00

(52) U.S. Cl. CPC H04N 5/23238; G06T 11/60; G06T 5/002; G06T 3/0018; H04N 5/23245; G02B 13/0005; G06T 2210/22; G06T 2207/10004

(57) ABSTRACT

An image processing device including an image obtaining circuit, a storage module and an image processing module is provided. The image obtaining circuit is for receiving a first fisheye image and a second fisheye image. The storage module is for storing a fisheye lens information. The image processing module is coupled to the image obtaining circuit and the storage module for generating a first converted image and a second converted image by converting the first and second fisheye images with panoramic coordinate conversion according to the fisheye lens information and stitching the first and second converted images to generate a panoramic image.

This application claims the benefit of Taiwan application Serial No. 104122716, filed Jul. 14, 2015, the disclosure of which is incorporated by reference herein in its entirety.

### TECHNICAL FIELD

The disclosure relates in general to an image processing method, an image processing device and a display system.

### BACKGROUND

Along with the development of multi-media technology, the application of digital image and digital video is getting more and more poplar, and various needs in the application of panoramic image, such as the needs for video conferencing and security surveillance, also arise.

Conventionally, the construction of a panoramic image is implemented by stitching a series of images shot by a user at different angles. During the process of generating the panoramic image, the computing device combines images according to the similarities between the images. Since such method consumes a large amount of computing resources and is normally implemented in an off-line manner, the panoramic image cannot be instantly displayed for the user to browse.

Therefore, how to provide a display technology capable of instantly displaying the panoramic image has become a prominent task for the industries.

### SUMMARY

The disclosure is directed to an image processing method, an image processing device and a display system for the user to view the panoramic image instantly.

According to one embodiment, an image processing device including an image obtaining circuit, a storage module and an image processing module is provided. The image obtaining circuit is for receiving a first fisheye image and a second fisheye image. The storage module is for storing a fisheye lens information. The image processing module is coupled to the image obtaining circuit and the storage module for generating a first converted image and a second converted image by converting the first and second fisheye images with panoramic coordinate conversion according to the fisheye lens information and stitching the first and second converted images to generate a panoramic image.

According to another embodiment, an image processing method is provided. The method includes following steps: receiving a first fisheye image and a second fisheye image; generating a first converted image and a second converted image by converting the first and second fisheye images with panoramic coordinate conversion according to the fisheye lens information; and stitching the first and second converted images to generate a panoramic image.

According to an alternative embodiment, a display system including an image capturing device and an image processing device is provided. The image capturing device includes a first fisheye lens module, a second fisheye lens module and a transmission circuit. The first fisheye lens module is for capturing a first fisheye image. The second fisheye lens module is for capturing a second fisheye image. The transmission circuit is for outputting the first and second fisheye images in the form of streams. The image processing device includes an image obtaining circuit, a storage module and an image processing module. The image obtaining circuit is for receiving the first and second fisheye images from the image capturing device. The storage module is for storing a fisheye lens information. The image processing module is coupled to the image obtaining circuit and the storage module for generating a first converted image and a second converted image by converting the first and second fisheye images with panoramic coordinate conversion according to the fisheye lens information and stitching the first and second converted images to generate a panoramic image.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a schematic diagram of an image processing system according to an embodiment of the invention.

FIG. 2 shows a schematic diagram of an image capturing device according to an embodiment of the invention.

FIG. 3 shows a flowchart of a method for panoramic coordinate conversion according to an embodiment of the invention.

FIG. 4 shows an example of a detailed flowchart of panoramic coordinate conversion.

FIG. 5 shows a schematic diagram of generating corresponding first and second converted images according to the first and second fisheye images captured by the image capturing device.

FIG. 6 shows a flowchart of a method for stitching images according to an embodiment of the invention.

FIG. 7 shows a schematic diagram of generating a panoramic image by stitching the first and second converted images of FIG. 4.

FIG. 8 shows a schematic diagram of an image processing system according to an embodiment of the invention.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

A number of embodiments are disclosed below for elaborating the invention. However, the embodiments of the invention are for detailed descriptions only, not for limiting the scope of protection of the invention. Furthermore, secondary or unimportant elements are omitted in the accompanying diagrams of the embodiments for highlighting the technical features of the invention.

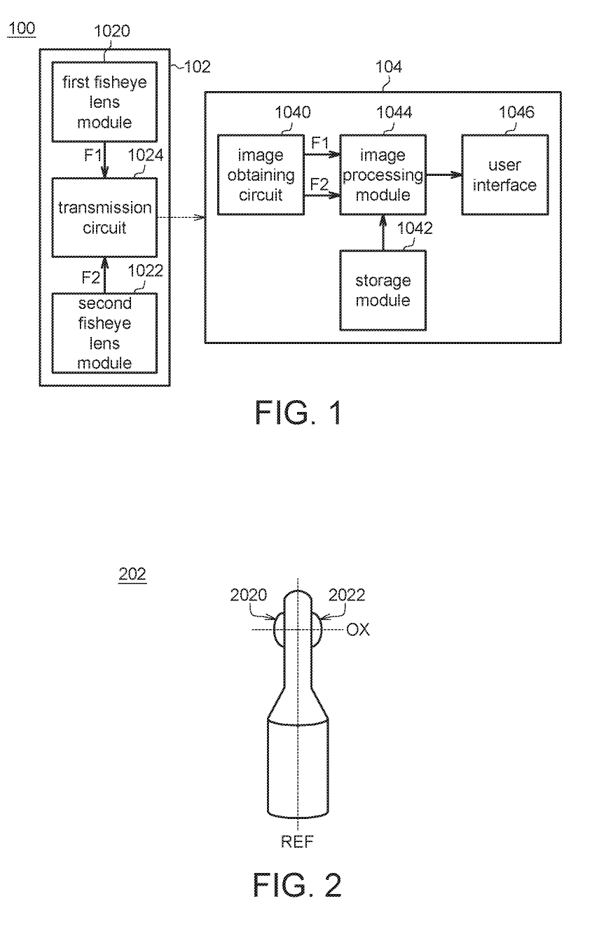

FIG. 1 shows a schematic diagram of an image processing system according to an embodiment of the invention. As indicated in FIG. 1, the image processing system 100 includes an image capturing device 102 and an image processing device 104. The image capturing device 102 is for capturing an ambient image and further transmitting the image data in the form of streams to the image processing device 104 for subsequent processing by way of wireless or wired communication.

The image capturing device 102 includes a first fisheye lens module 1020, a second fisheye lens module 1022 and a transmission circuit 1024. The first fisheye lens module 1020 and the second fisheye lens module 1022 can be realized by video recorders, cameras or image capturing modules equipped with fisheye lens for capturing images from different fields of views. Since the fisheye lens has the feature of ultra-wide angle, a panoramic image with ultra-wide field of vision can be obtained by stitching the images captured by the first fisheye lens module 1020 and the second fisheye lens module 1022 whose relative positions are suitable arranged.

The transmission circuit 1024 can encode and stream image data and further transit the encoded streaming image data to the image processing device 104 by way of wireless or wired communication. As indicated in FIG. 1, the transmission circuit 1024 receives a first fisheye image F1 and a second fisheye image F2 from the first fisheye lens module 1020 and the second fisheye lens module 1022 respectively, encodes and streams the received first and second fisheye images F1 and F2, and transmits the encoded streaming data to the image processing device 104.

The image processing device 104 can be realized by a portable electronic device (mobile carrier such as smart phone, notebook computer, or tablet PC), personal computer, monitoring equipment, or any electronic device with image processing function. The image processing device 104 mainly includes an image obtaining circuit 1040, a storage module 1042 and an image processing module 1044. The image obtaining circuit 1040 is for receiving a first fisheye image F1 and a second fisheye image F2. In the present example, the image obtaining circuit 1040, such as a reception circuit, can decode the received streaming data to obtain the first fisheye image F1 and the second fisheye image F2.

The storage module 1042 is for storing a fisheye lens information, and the storage can be implemented by various storage media such as memory circuit and lookup table. The fisheye lens information can be any lens parameters associated with the first fisheye lens module 1020 and the second fisheye lens module 1022. Examples of the lens parameters include lens center position, focal length and view angle. The fisheye lens information can be obtained through lens calibration performed before the image capturing device 102 leaves the factory. The fisheye lens information is provided to the image processing module 1044 for subsequent image processing.

The image processing module 1044 is coupled to the image obtaining circuit 1040 and the storage module 1042 for generating a first converted image and a second converted image by converting the first fisheye image F1 and the second fisheye image F2 with panoramic coordinate conversion according to the fisheye lens information and stitching the first and second converted images to generate a panoramic image. The image processing module 1044 can be implemented by processor, chip, hardware circuits, software programs, firmware or medium storing instructions for execution.

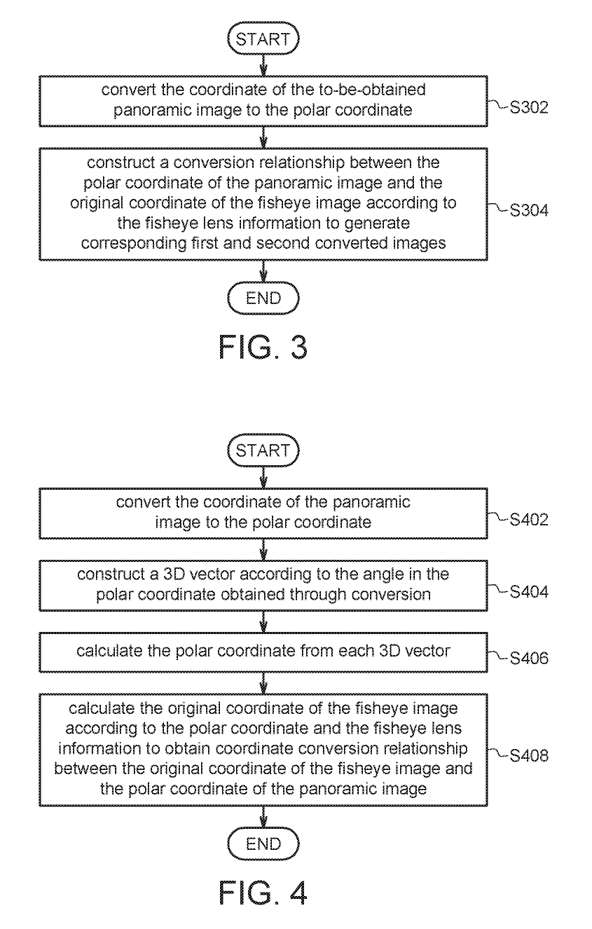

Panoramic coordinate conversion disclosed above can be used to eliminate the distortion in the image content of the first fisheye image F1 and the second fisheye image F2. Therefore, a panoramic image with ultra-wide field of vision or full field can be obtained by suitably stitching the first and second converted images generated from panoramic coordinate conversion. Details of panoramic coordinate conversion and stitching process are disclosed with reference to FIGS. 3-7.

The image processing system 100 further includes a user interface 1046 for selecting a viewing mode in response to an external instruction, such that the panoramic image is converted into a display image corresponding to the viewing mode. The user interface 1046 can be realized by a touch screen or an interface with operation display function. Examples of the viewing mode include sphere mode, panorama mode and fisheye mode. However, the invention is not limited thereto, and the said viewing mode can also be realized by other browsing modes with different visual effects.

For example, suppose the image capturing device 102 is a monitor installed at a remote end, and the image processing device 104 is a smart phone. The image processing device 104 can use an APP to decode and convert the image streaming data, transmitted by the image capturing device 102 from a remote end, with panoramic coordinate conversion. The dual-band images (that is, the first and second converted images) can be cropped and stitched to generate a corresponding panoramic image. The image processing module 1044 can perform parameter computation for various visual fields such that the user can browse the panoramic image at a remote end through the selected viewing mode.

Since the image processing device of the invention can instantly convert the received first and second fisheye images with panoramic coordinate conversion according to the fisheye lens information and stitch the converted imaged, the scenery shot by the image capturing device can be instantly displayed on the browser window in a viewing mode preferred by the user. In an embodiment, the image processing device further increases the overall video display efficiency using the OpenGL and/or digital signal processing technology.

FIG. 2 shows a schematic diagram of an image capturing device according to an embodiment of the invention. As indicated in FIG. 2, the image capturing device 202 includes a first fisheye lens module 2020 and a second fisheye module 2022. The first fisheye lens module 2020 and the second fisheye lens module 2022 are oppositely disposed on two sides of an optical axis OX around a reference dummy line REF and facing outwardly. The first fisheye lens module 2020 and the second fisheye lens module 2022 have an ultra-wide angle larger than 190°. Therefore, the first fisheye image shot by the first fisheye lens module 2020 almost covers the scenery at the left-hand side of the image capturing device 202, and the second fisheye image shot by the second fisheye lens module 2022 almost covers the right-hand side of the image capturing device 202. Thus, a 720° (full field) panoramic image can be generated by suitably converting the first and second fisheye images with panoramic coordinate conversion and stitching the converted images. It is understood that the invention is not limited to the above exemplifications. Relative position between the first and second fisheye lens modules 2020 and 2022 and the specification of the fisheye lens can be adjusted according to actual needs. For example, the optical axis of the first fisheye lens module 2020 and the optical axis of the second fisheye lens module 2022 can be non-parallel to each other, and the wide-angle of the fisheye lens can be larger than or smaller than 190°. Besides, the panoramic image is not limited to 720°. For example, the panoramic image can be smaller than 720° and the angle depends on actual needs of application.

FIG. 3 shows a flowchart of a method for panoramic coordinate conversion according to an embodiment of the invention. As disclosed above, the distortion in the image content of the first and second fisheye images can be eliminated through panoramic coordinate conversion. Refer to FIG. 3. Firstly, the method begins at step S302, the image processing module converts the coordinate of the to-be-obtained panoramic image to the polar coordinate. Then, in step S304, the image processing module construct a conversion relationship between the polar coordinate of the panoramic image and the original coordinate of the fisheye image according to the fisheye lens information to generate corresponding first and second converted images for subsequent stitching processing.

FIG. 4 shows an example of a detailed flowchart of panoramic coordinate conversion. Firstly, the method begins at step S402, the image processing module converts the coordinate of the panoramic image to the polar coordinate. For example, the image processing module calculates the angle (⊖, Ø) in the polar coordinate for any image point (x, y) in the coordinate of the panoramic image.

⊖=PI×(x/width−0.5)

Ø=PI×(y/height−0.5)

Wherein PI represents circular ratio; width represents image width; and height represents image height.

Then, in step S404, the image processing module constructs a 3D vector according to the angle in the polar coordinate obtained through conversion. For example, the image processing module constructs 3D vectors (spX, spY, spZ) using the angle (⊖, Ø) in the polar coordinate according to the following formulas:

spX=cos Ø×sin ⊖

spY=cos Ø×cos ⊖

spZ=sin Ø

Then, in step S406, the image processing module calculates the polar coordinate (r, ⊖1, Ø1) from the 3D vectors (spX, spY, spZ) according to the following formulas.

⊖1=arctan(spZ/spX)

Ø1=arctan(sqrt(spX×spX+spZ×spZ)/spY)

r=width×Ø1/FOV

Wherein FOV represents the scope of visual field. Lastly, in step S408, the image processing module calculates the original coordinate (x1, y1) of the fisheye image according to the polar coordinate (r, ⊖1) and the fisheye lens information:

x1=Cx+r×cos ⊖1

y1=Cy+r×sin ⊖1

Wherein, Cx and Cy represent coordinates of the center position of calibrated fisheye lens. Thus, coordinate conversion relationship between the original coordinate of the fisheye image and the polar coordinate of the panoramic image can be obtained. However, the invention is not limited to the above exemplifications. Panoramic coordinate conversion can also be implemented through other 2D/3D coordinate conversion. Besides, the parameters in the above formulas are merely an exemplification, and can be adjusted according to different display needs.

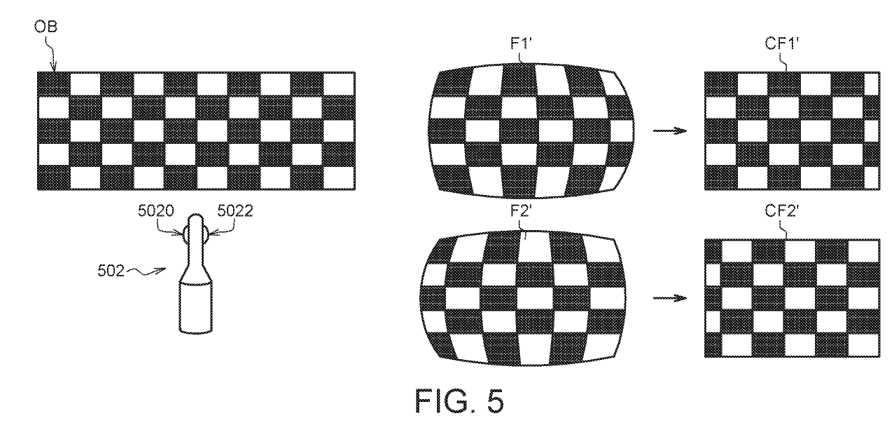

FIG. 5 shows a schematic diagram of generating corresponding first and second converted images according to the first and second fisheye images captured by the image capturing device. In the example of FIG. 5, the image capturing device 502 shots an object OB using a first fisheye lens module 5020 and a second fisheye lens module 5022 to generate a first fisheye image F1′ and a second fisheye image F2′. Based on the features of ultra-wide angle of the fisheye lens, the image content of the first and second fisheye images F1′ and F2′ are distorted in comparison to actual object OB as indicated in FIG. 5. Then, the first and second fisheye images F1′ and F2′ are calibrated through panoramic coordinate conversion to obtain a first converted image CF1′ and a second converted image CF2′. In the present example, the image content of the first converted image CF1′ corresponds to the left-hand side of the object OB, and the image content of the second converted image CF2′ corresponds to the right-hand side of the object OB.

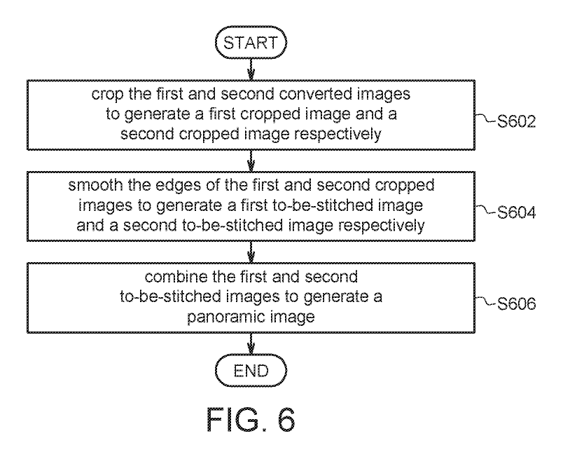

As disclosed above, the image processing module can obtain the panoramic image with wider field of vision by suitably stitching the first and second converted images. FIG. 6 shows a flowchart of a method for stitching images according to an embodiment of the invention. Firstly, the method begins at step S602, the image processing module crops the first and second converted images to generate a first cropped image and a second cropped image respectively. Then, in step S604, the image processing module smooths the edge of the first and second cropped images to generate a first to-be-stitched image and a second to-be-stitched image respectively. Then, in step S606, the image processing module combines the first and second to-be-stitched images to generate a panoramic image.

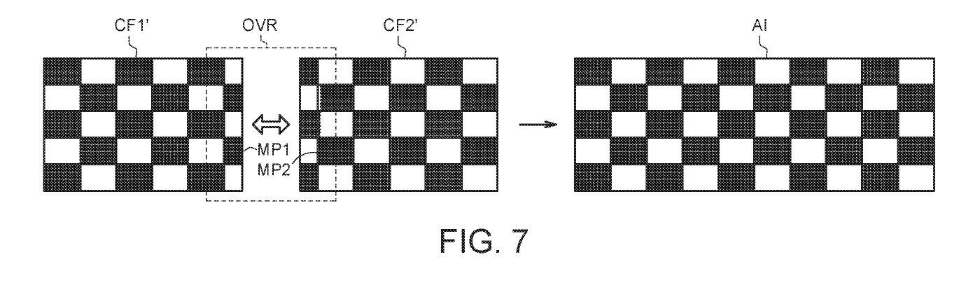

FIG. 7 shows a schematic diagram of generating a panoramic image by stitching the first and second converted images of FIG. 4. As indicated in FIG. 7, each of the first converted image CF1′ and the second converted image CF2′ has an image overlapping region OVR. The image content of the image overlapping region OVR corresponds to the overlapping region of the image shot from the view angel of the first fisheye lens module 5020 and from the view angle of the second fisheye lens module 5022.

To suitably stitch the first and second converted images CF1′ and CF2′, the image processing module captures the edge features of the first and second converted image CF1′ and CF2′ from the image overlapping region OVR. The edge features can be captured using various image processing technologies by judging image contrast, color difference, or pattern continuity.

Theoretically, the image content of the first and second converted images CF1′ and CF2′ in the image overlapping region OVR is repetitive or similar. Therefore, the image processing module can determine the image stitching point according to the degree of similarity between the features of the first and second images. As indicated in FIG. 7, the first converted image CF1′ includes a plurality of first image features MP1, and the second converted image CF2′ includes a plurality of second image features MP2. Suppose the degree of similarity between the first image features MP1 and the second image features MP2 is higher than a predetermined value (or the degree of similarity is the largest among the image features), the image processing module determines the first and second image features MP1 and MP2 as image stitching points, that is, alignment points at which two images are stitched.

After the image stitching points are determined, the image processing module can crop and stitch the first converted image CF1′ and the second converted image CF2′ according to the image stitching points. The edge at which two images are stitched is smoothed according to the ratio of the pixel value of the image and the distance to the overlapping boundary. Then, the images are smoothed, combined and outputted to generate a panoramic image AI.

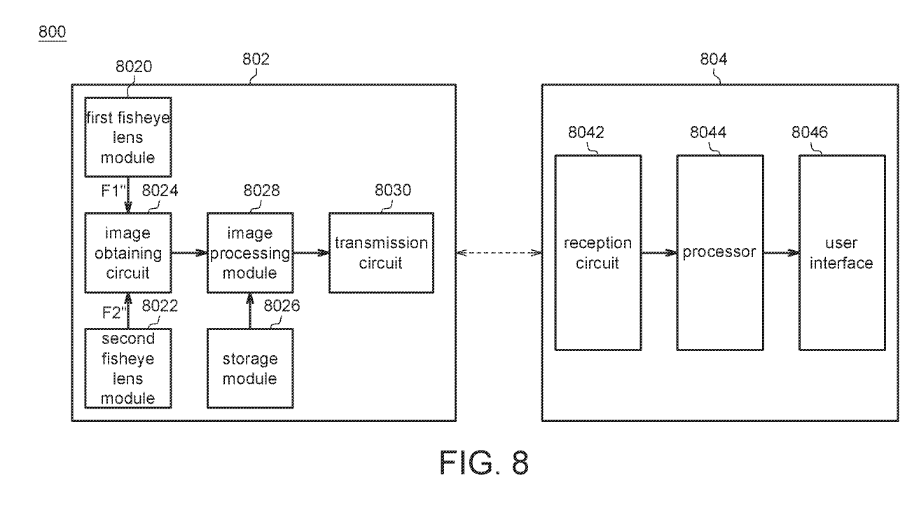

In an embodiment, the image processing device can be disposed in the image capturing device. As indicated in FIG. 8, a schematic diagram of an image processing system according to an embodiment of the invention is shown. In the example of FIG. 8, the image processing system 800 includes an image capturing device 802 and a terminal device 804. The terminal device 804 can be realized by an electronic device with operation display function such as a portable device. The image processing system 800 is different from the image processing system 100 of FIG. 1 mainly in that the image capturing device 802 of the present embodiment can implement the image processing function of the image processing device 104 such as panoramic coordinate conversion and stitching processing, and can further transmit the stitched panoramic image to the terminal device 804 which shows different viewing modes preferred by the user.

As indicated in FIG. 8, the image capturing device 802 includes a first fisheye lens module 8020, a second fisheye lens module 8022, an image obtaining circuit 8024, a storage module 8026, an image processing module 8028 and a transmission circuit 8030. The image obtaining circuit 8024 receives a first fisheye image F1″ and a second fisheye image F2″ from a first fisheye lens module 8020 and a second fisheye lens module 8024, respectively. After receiving the first and second fisheye images F1″ and F2″ from the image obtaining circuit 8024, the image processing module 8028 can convert the first and second fisheye images F1″ and F2″ with panoramic coordinate conversion to generate first and second converted images according to the fisheye lens information of the storage module 8026 and further stitch the converted images to generate a panoramic image and output the panoramic image to the transmission circuit 8030. Then, the transmission circuit 8030 transmits the panoramic image to the terminal device 804 in the form of streams by way of wireless or wired communication.

The terminal device 804 includes a reception circuit 8042, a processor 8044 and a user interface 8046. The reception circuit 8042 receives and decode the received streaming data to obtain a panoramic image. Through the computation of the processor 8044, the user interface 8046 can display the panoramic image in a selected viewing mode preferred by the user.

To summarize, the wide visual field of double fisheye lens used in the image processing method, the image processing device and the display system of the invention overcomes the restraint of visual field to which an ordinary lens is subjected. Through the pre-stored fisheye lens information and the streaming technology, the image processing device can instantly calibrate and stitch the dual-channel fisheye images to generate a corresponding panoramic image, which provides the user with a panoramic viewing experience.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An image processing device, comprising:
an image obtaining circuit for receiving a first fisheye image and a second fisheye image;
a storage module for storing a fisheye lens information; and
an image processing module coupled to the image obtaining circuit and the storage module for converting the first and second fisheye images with panoramic coordinate conversion according to the fisheye lens information to generate a first converted image and a second converted image and stitching the first and second converted images to generate a panoramic image.

2. The image processing device according to claim 1, wherein the image processing module comprises:
an element for calculating coordinate conversion relationship between the first and second fisheye images and the panoramic image according to the fisheye lens information; and
an element for converting the first and second fisheye images into the first and second converted images according to the coordinate conversion relationship.

3. The image processing device according to claim 1, wherein the image processing module comprises:
an element for cropping the first and second converted images to generate a first cropped image and a second cropped image respectively;
an element for smoothing the edges of the first and second cropped images to generate a first to-be-stitched image and a second to-be-stitched image respectively; and
an element for stitching the first and second to-be-stitched images to generate a panoramic image.

4. The image processing device according to claim 1, wherein the fisheye lens information comprises a lens center position of a first fisheye lens module for capturing the first fisheye image and a lens center position of a second fisheye lens module for capturing the second fisheye image.

5. The image processing device according to claim 4, wherein the first fisheye and second fisheye lens modules are oppositely disposed on two sides of an optical axis around a reference dummy line and facing outwardly.

6. The image processing device according to claim 1, wherein the panoramic image is 720°.

7. The image processing device according to claim 1, further comprising:
a user interface for selecting a viewing mode in response to an external instruction, such that the panoramic image is converted to a display image corresponding to the viewing mode.

8. The image processing device according to claim 7, wherein the viewing mode comprises sphere mode, panorama mode and fisheye mode.

9. An image processing method, comprising:
receiving a first fisheye image and a second fisheye image;
converting the first and second fisheye images with panoramic coordinate conversion according to a fisheye lens information to generate a first converted image and a second converted image; and
stitching the first and second converted images to generate a panoramic image.

10. The image processing method according to claim 9, further comprising:
calculating coordinate conversion relationship between the first and second fisheye images and the panoramic image according to the fisheye lens information; and
converting the first and second fisheye images into the first and second converted images according to the coordinate conversion relationship.

11. The image processing method according to claim 9, further comprising:
cropping the first and second converted images to generate a first cropped image and a second cropped image respectively;
smoothing the edges of the first and second cropped images to generate a first to-be-stitched image and a second to-be-stitched image respectively; and
stitching the first to-be-stitched image and the second to-be-stitched image to generate a panoramic image.

12. The image processing method according to claim 9, wherein the fisheye lens information comprises a lens center position of a first fisheye lens module for capturing the first fisheye image and a lens center position of a second fisheye lens module for capturing the second fisheye image.

13. The image processing method according to claim 12, wherein the first fisheye and second fisheye lens modules are oppositely disposed on two sides of an optical axis around a reference dummy line and facing outwardly.

14. The image processing method according to claim 9, wherein the panoramic image is 720°.

15. The image processing method according to claim 9, further comprising:
selecting a viewing mode in response to an external instruction through a user interface, such that the panoramic image is converted to a display image corresponding to the viewing mode.

16. The image processing method according to claim 15, wherein the viewing mode comprises sphere mode, panorama mode and fisheye mode.

17. A display system, comprising:
an image capturing device, comprising:
a first fisheye lens module for capturing a first fisheye image;
a second fisheye lens module for capturing a second fisheye image; and
a transmission circuit for outputting the first and second fisheye images in the form of streams; and
an image processing device, comprising:
an image obtaining circuit for receiving the first and second fisheye images from the image capturing device;
a storage module for storing a fisheye lens information; and
an image processing module coupled to the image obtaining circuit and the storage module for converting the first and second fisheye images with panoramic coordinate conversion according to the fisheye lens information to generate a first converted image and a second converted image and stitching the first and second converted images to generate a panoramic image.

18. The display system according to claim 17, wherein the first fisheye and second fisheye lens modules are oppositely disposed on two sides of an optical axis around a reference dummy line and facing outwardly.

19. The display system according to claim 17, wherein the image processing device further comprises:
a user interface for selecting a viewing mode in response to an external instruction, such that the panoramic image is converted to a display image corresponding to the viewing mode.

20. The display system according to claim 19, wherein the viewing mode comprises sphere mode, panorama mode and fisheye mode.
